(19) United States
(12) Patent Application Publication
(10) Pub. No.: US 2010/0029161 A1
(43) Pub. Date: Feb. 4, 2010

(54) MICRODENIER FIBERS AND FABRICS INCORPORATING ELASTOMERS OR PARTICULATE ADDITIVES

(75) Inventor: Benham Pourdeyhimi, Cary, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: North Carolina State University

(21) Appl. No.: 12/543,636

(22) Filed: Aug. 19, 2009

Related U.S. Application Data
(63) Continuation-in-part of application No. 11/769,871, filed on Jun. 28, 2007.
Application No. 11/769,871 is a continuation-in-part of application No. 11/473,534, filed on Jun. 23, 2006.
(60) Provisional application No. 60/694,121, filed on Jun. 24, 2005.

(51) Int. Cl. D01D 5/34; D04H 5/00; B32B 5/16; D01D 5/08; D01F 8/04; D04H 1/46

(52) U.S. Cl. 442/329; 428/373; 442/346; 442/337; 442/338; 264/172.15; 264/145; 28/104

(57) ABSTRACT

Multicomponent fiber and fabrics made therefrom are provided, wherein the multicomponent fibers may incorporate one or more elastomers or additive-containing polymers in a bicomponent core. The fiber includes a multilobal sheath fiber component surrounding the bicomponent core, wherein the components are sized such that the fiber can be fibrillated to expose the core fiber components and split the fiber into multiple microdenier fibers.

### CROSS-REFERENCE TO RELATED APPLICATIONS

This application is a continuation-in-part of U.S. application Ser. No. 11/769,871, filed Jun. 28, 2007, which is a continuation-in-part of U.S. application Ser. No. 11/473,534, filed Jun. 23, 2006, which claim priority to U.S. Provisional Patent Application Ser. No. 60/694,121, filed Jun. 24, 2005, all of which are incorporated herein by reference in their entirety.

### FIELD OF THE INVENTION

The invention relates generally to the manufacture of microdenier fibers and nonwoven products manufactured from such fibers. The fibers may contain one or more elastomers and/or particulate additives.

### BACKGROUND OF THE INVENTION

Nonwoven spunbonded fabrics are used in many applications requiring a lightweight disposable fabric. Therefore, most spunbonded fabrics are designed for single use and are designed to have adequate properties for the applications for which they are intended. Spunbonding refers to a process where the fibers (filaments) are extruded, cooled, and drawn and subsequently collected on a moving belt to form a fabric. The web thus collected is not bonded and the filaments must be bonded together thermally, mechanically, or chemically to form a fabric.

Microdenier fibers are fibers which are typically smaller than 1 denier. Typically, microdenier fibers are produced utilizing a bicomponent fiber configured to split, such as “pie wedge” or “segmented pie” fibers. U.S. Pat. No. 5,783,503 illustrates a typical meltspun multicomponent thermoplastic continuous filament which is split absent mechanical treatment. In the configuration described, it is desired to provide a hollow core filament. The hollow core prevents the tips of the wedges of like components from contacting each other at the center of the filament and promotes separation of the filament components.

In these configurations, the components are segments typically made from nylon and polyester. It is common for such a fiber to have 16 segments. The conventional wisdom behind such a fiber has been to form a web of typically 2 to 3 denier per filament fibers by means of carding and/or airlay, and subsequently split and bond the fibers into a fabric in one step by subjecting the web to high pressure water jets. The resultant fabric will be composed of microdenier fibers and will possess all of the characteristics of a microdenier fabric with respect to softness, drape, cover, and surface area.

There is considerable interest in forming microdenier fibers and nonwovens with components incorporating one or more elastomeric polymers and/or additive-containing polymers. In fibers that include elastomeric components, the elastomers have typically only been used in the core component. This is partly because the elastomers do not solidify, crystallize rapidly, and remain tacky. Thus, during extrusion, the elastomers tend to stick together and form bundles, which results in poor fabric formation. To date, spunbonded elastomers where the elastomer is exposed have not been produced successfully in nonwovens.

Particulate materials may be added to polymers used in fibers in order to add certain functionalities to the fibers. For example, ceramic or metal oxide nanoparticles, silver nanoparticles, carbon nanotubes, photo-luminescent additives, or surfactants can be added in small amounts to a polymer, which can subsequently be used to produce a fiber. However, high concentrations of additives within the polymer can result in fibers breaking during extrusion. In bicomponent fibers, such additives have previously been added to the core or the sheath in small quantities, but in splittable fibers, the addition of such additives typically results in fiber breakage during extrusion. Although not directed to splittable fibers, U.S. Pat. No. 4,207,376 relates to multicomponent antistatic filaments comprising a core component, sheath component, and a layer between these two components that may comprise electrically conductive carbon black.

When manufacturing bicomponent fibers for splitting, several fiber characteristics are typically considered to ensure that a continuous fiber may be adequately manufactured. These characteristics include miscibility of the components, differences in melting points, crystallization properties, viscosity, and ability to develop a triboelectric charge. The individual components of bicomponent fibers are typically selected so that characteristics between the bicomponent fiber components are sufficiently accommodating for fiber spinning. Suitable combinations of polymers include polyester and polypropylene, polyester and polyethylene, nylon and polypropylene, nylon and polyethylene, and nylon and polyester. Since these bicomponent fibers are spun in a segmented cross-section, each component is exposed along the length of the fiber. Consequently, if the components selected do not have properties which are closely analogous, the continuous fiber may suffer defects during manufacturing such as breaking or crimping. Such defects would render the filament unsuitable for further processing.

U.S. Pat. No. 6,448,462 discloses another multicomponent filament having an orange-like multisegment structure representative of a pie configuration. This patent also discloses a side-by-side configuration. In these configurations, two incompatible polymers such as polyesters and a polyethylene or polyamide are utilized for forming a continuous multicomponent filament. These filaments are melt-spun, stretched and directly laid down to form a nonwoven. The use of this technology in a spunbond process coupled with hydro-splitting is now commercially available as a product marketed under the EVOLON® trademark by Freudenberg and is used in many of the same applications described above.

The segmented pie is only one of many possible splittable configurations. In the solid form, it is easier to spin, but in the hollow form, it is easier to split. To ensure splitting, dissimilar polymers are utilized. But even after choosing polymers with low mutual affinity, the fiber's cross section can have an impact on how easily the fiber will split. The cross section that is most readily splittable is a segmented ribbon. The number of segments has to be odd so that the same polymer is found at both ends so as to “balance” the structure. This fiber is anisotropic and is difficult to process as a staple fiber, but can work as a continuous filament. Therefore, in the spunbonding process, this fiber can be attractive. Processing is improved in certain fiber cross-sections such as tipped trilobal or segmented cross.

Another disadvantage utilizing segmented pie configurations is that the overall fiber shape upon splitting is a wedge shape. This configuration is a direct result of the process to producing the small microdenier fibers. Consequently, while suitable for their intended purpose, nonetheless, other shapes of fibers may be desired which produce advantageous application results. Such shapes are currently unavailable under standard segmented processes.

Accordingly, when manufacturing microdenier fibers utilizing the segmented pie format, certain limitations are placed upon the selection of materials. While the components of the fiber must be constructed of sufficiently different material so the adhesion between the components is minimized and separation is facilitated, the components nonetheless also must be sufficiently similar in characteristics in order to enable the fiber to be manufactured during a spunbond or meltblown process. If the materials are too dissimilar, the fibers will break during processing.

Another method of creating microdenier fibers utilizes fibers of the island in the sea configuration. U.S. Pat. No. 6,455,156 discloses one such structure. In an island in the sea configuration, a primary fiber component, the sea, is utilized to envelope smaller interior fibers, the islands. Such structures provide for ease of manufacturing, but require the removal of the sea in order to reach the islands. This is done by dissolving the sea in a solution which does not impact the islands. Such a process is not environmentally friendly as an alkali solution is often utilized, which may require wastewater treatment. Additionally, since it is necessary to expose the island components to the solvent that dissolves the sea, this method restricts the types of polymers which may be utilized as islands to those not affected by the solvent that dissolves the sea.

Such island-in-the-sea fibers are commercially available today in staple form (fiber lengths typically up to 75 mm). They are most often used in making synthetic leathers and suedes through needlepunching and crosslapping processes. In the case of synthetic leathers, a subsequent step introduces coagulated polyurethane into the fabric, and may also include a top coating. Another end-use that has resulted in much interest in such fibers is in technical wipes, where the small fibers lead to a large number of small capillaries resulting in better fluid absorbency and better dust pick-up. For a similar reason, such fibers may be of interest in filtration.

In summary, what has been accomplished so far has limited application because of the limitations posed by the choice of the polymers that would allow ease of spinning and splittability for segmented fibers. The spinning is problematic because both polymers are exposed on the surface and therefore, variations in elongational viscosity, quench behavior, and relaxation cause anisotropies that lead to spinning challenges. Furthermore, the incorporation of elastomer-containing components and additive-containing polymeric components within the fibers has been problematic. When a fiber contains elastomeric components, the tackiness of the elastomeric components typically leads to bundled fibers during extrusion. When a fiber contains additive-containing polymeric components, the additive concentration within the fiber is limited due to the likelihood of fiber breakage during extrusion. Still further, a major limitation of the current art is that the fibers form wedges and there is no flexibility with respect to fiber cross sections that can be achieved.

An advantage with an island in the sea technology is that if the spinpack is properly designed, the sea can act as a shield and protect the islands so as to reduce spinning challenges. However, with the requirement of removing the sea, limitations exist due to limited availability of suitable polymers for the sea and island components. Prior to the inventive activity set forth in the related patent applications, islands in the sea technology has not been employed for making microdenier fibers other than via the removal of the sea component because of the common belief that the energy required to separate the islands from the sea renders this process commercially unviable.

Accordingly, there is a need for a manufacturing process which can produce microdenier fiber dimensions in a manner which is conducive to spunbound processing and which is environmentally sound. Further, there is a need for a process by which elastomers and additive-containing polymers can be incorporated within a fiber and subsequently spunbonded to produce nonwoven fabrics.

### SUMMARY OF THE INVENTION

The present invention provides multicomponent fibers that may be fibrillated to form fiber webs comprising multiple microdenier fibers. In some embodiments, the multicomponent fibers are multilobal. The fibers of the invention can be used to form fabrics that exhibit a high degree of strength and durability due to the splitting and intertwining of the lobes of the fibers during processing. In particular, one embodiment of the invention provides a multicomponent, multilobal fiber comprising a bicomponent core. The bicomponent core may comprise an inner component and an outer component encapsulating said inner component, wherein the outer component may be an elastomer or a polymer containing a particulate additive, and wherein the bicomponent core is enwrapped by a multilobal sheath fiber component such that the sheath fiber component forms the entire outer surface of the multicomponent fiber. The bicomponent core and the sheath fiber component may be sized such that the multicomponent, multilobal fiber can be fibrillated to expose the bicomponent core and split the fiber into multiple microdenier fibers. Thus, in another aspect of the invention is provided a fabric comprising microdenier fibers, the microdenier fibers prepared by fibrillating a multicomponent, multilobal fiber comprising a contiguous core fiber component enwrapped by a multilobal sheath fiber component such that the sheath fiber component forms the entire outer surface of the multicomponent fiber, wherein the core fiber component and the multilobal sheath fiber component are sized such that the multicomponent, multilobal fiber can be fibrillated to expose the core fiber component and split the fiber into multiple microdenier fibers.

In embodiments wherein the sheath fiber is multilobal, exemplary sheath fiber components have 3 to about 18 lobes. Trilobal sheath components are particularly preferred. The volume of the core fiber component is typically about 10 to about 90 percent of the multicomponent fiber, with the remainder being the sheath fiber component.

Although the polymers used in each portion of the fiber can vary, the core fiber component and the sheath fiber component each preferably comprise a different thermoplastic polymer selected from the following group: polyesters, polyamides, copolyetherester elastomers, polyolefins, polyurethanes, polyvinylidene fluoride (PVDF), polyacrylates, cellulose esters, liquid crystalline polymers, and mixtures thereof. In one embodiment, at least one of the core fiber component and the multilobal sheath fiber component comprises a polymer selected from the group consisting of nylon 6, nylon 6/6, nylon 6,6/6, nylon 6/10, nylon 6/11, nylon 6/12, and mixtures thereof. In a particularly preferred embodiment, the core fiber component comprises a polyamide or polyester polymer and the multilobal sheath fiber component comprises a polyolefin, polyamide, polyester, or co-polyester, wherein the core fiber component polymer and the multilobal sheath fiber component polymer are different.

The core fiber component is advantageously a bicomponent fiber component comprising an outer component encapsulating an inner component. The inner component of the bicomponent core optionally comprises one or more void spaces. Typically, both the inner component and the outer component of the core fiber component have a cross-sectional shape independently selected from the following group: circular, rectangular, square, oval, triangular, and multilobal. In one embodiment, both the inner component and the outer component of the bicomponent core have a round or triangular cross-section, and the inner component optionally comprises one or more void spaces. The inner component of the bicomponent core optionally has a multilobal cross-sectional shape. It is preferred for the inner component of the bicomponent core to comprise the same polymer as the exterior sheath fiber component. Typically, the outer component of the bicomponent core comprises less than about 50% by volume of the multicomponent fiber, preferably less than about 20% by volume of the multicomponent fiber, and even more preferably less than about 15% by volume of the multicomponent fiber.

The multicomponent fiber may contain one or more elastomers and/or additive-containing polymers. In one aspect, the multicomponent fiber may comprise a bicomponent core wherein the bicomponent core comprises an inner component and an outer component encapsulating said inner component. The outer component may be selected from the group consisting of an elastomer and a polymer containing a particulate additive, wherein the bicomponent core is enwrapped by a sheath fiber component such that the sheath fiber component forms the entire outer surface of the multicomponent fiber. In such embodiments, the bicomponent core and the sheath fiber component are sized such that the multicomponent, multilobal fiber can be fibrillated to expose the bicomponent core and split the fiber into multiple microdenier fibers. The inner component of the core fiber component may comprise a void space and both the inner component and the outer component of the core fiber component may have various cross-sectional shapes. Preferably, the exterior sheath fiber component is multilobal.

In any of the above embodiments, the core fiber component, or a portion thereof can be soluble in a solvent such as water or a caustic solution.

In another aspect of the invention is provided a spunbonded fabric prepared from the fibers. The fabric of the invention can be woven, knitted, or nonwoven, but hydroentangled nonwoven fabrics are particularly preferred. In one embodiment, the invention relates to a nonwoven, spunbonded fabric prepared by fibrillation of a plurality of multicomponent fibers according to the invention, said fibrillation causing the multicomponent fibers to split into a plurality of microdenier fibers. The fibers used to prepare the fabric may comprise elastomeric or additive-containing components, which can endow the resulting fabrics with various different properties. In one preferred embodiment, a hydroentangled, nonwoven fabric comprising microdenier fibers is provided, the microdenier fibers prepared by fibrillating a multicomponent, trilobal fiber comprising a contiguous core fiber component enwrapped by a multilobal sheath fiber component such that the sheath fiber component forms the entire outer surface of the multicomponent fiber, wherein the core fiber component and the multilobal sheath fiber component are sized such that the multicomponent, multilobal fiber can be fibrillated to expose the core fiber component and split the fiber into multiple microdenier fibers, and wherein the fibrillating step comprises hydroentangling the multicomponent, trilobal fibers.

In a still further aspect of the invention, a method of preparing a nonwoven fabric comprising microdenier fibers is provided. The method comprises meltspinning a plurality of multicomponent, multilobal fibers comprising a contiguous core fiber component enwrapped by a multilobal sheath fiber component such that the sheath fiber component forms the entire outer surface of the multicomponent fiber, wherein the core fiber component and the multilobal sheath fiber component are sized such that the multicomponent, multilobal fibers can be fibrillated to expose the core fiber component and split the fibers into multiple microdenier fibers; forming a spunbonded web comprising the multicomponent, multilobal fibers; and fibrillating the multicomponent, multilobal fibers to expose the core fiber component and split the fibers into multiple microdenier fibers to form a nonwoven fabric comprising microdenier fibers. The fibrillating step can comprise hydroentangling the multicomponent, multilobal fibers, such as by exposing the spunbonded web to water pressure from one or more hydroentangling manifolds at a water pressure in the range of 10 bar to 1000 bar. The nonwoven fabric can also be thermally bonded if desired prior to or after the fibrillating step, and optionally the fabric can be needle punched prior to fibrillation.

In an additional aspect of the invention, a method of preparing a stretchable nonwoven fabric is provided, wherein one component is an elastomer. Said nonwoven may have stretch and full recovery only in one direction (Machine or Cross) or in both directions. In another aspect, a method of preparing a nonwoven fabric with particulate additive-containing polymer components is provided. The method of preparing such nonwoven fabrics comprises meltspinning a plurality of multicomponent fibers comprising a bicomponent core, wherein the bicomponent core comprises an inner component and an outer component. The outer component may be selected from the group consisting of an elastomer and a polymer containing a particulate additive, and the bicomponent core may be enwrapped by a sheath fiber component such that the sheath fiber component forms the entire outer surface of the multicomponent fiber. A spunbonded web may then be formed, comprising the multicomponent fibers. In certain embodiments, the exterior sheath fiber component is multilobal, and the bicomponent core and the multilobal sheath fiber component are sized such that the multicomponent, multilobal fibers can be fibrillated to expose the core fiber component and split the fibers into multiple microdenier fibers. In such embodiments, a microdenier fabric may be prepared. This process comprises meltspinning a plurality of multicomponent, multilobal fibers comprising a contiguous core fiber component enwrapped by a multilobal sheath fiber component such that the sheath fiber component forms the entire outer surface of the multicomponent fiber, wherein the core fiber component and the multilobal sheath fiber component are sized such that the multicomponent, multilobal fibers can be fibrillated to expose the core fiber component and split the fibers into multiple microdenier fibers; forming a spunbonded web comprising the multicomponent, multilobal fibers; and fibrillating the multicomponent, multilobal fibers to expose the core fiber component and split the fibers into multiple microdenier fibers to form a nonwoven fabric comprising microdenier fibers. Preferably, the core component is bicomponent, wherein the outer component of the bicomponent core is an elastomer. The fibrillating step can comprise hydroentangling the multicomponent, multilobal fibers, such as by exposing the spunbonded web to water pressure from one or more hydroentangling manifolds at a water pressure in the range of 10 bar to 1000 bar. The nonwoven fabric can also be thermally bonded if desired prior to or after the fibrillating step, and optionally the fabric can be needle punched prior to fibrillation.

### BRIEF DESCRIPTION OF THE DRAWINGS

The methods and systems designed to carry out the invention will hereinafter be described, together with other features thereof. The invention will be more readily understood from a reading of the following specification and by reference to the accompanying drawings forming a part thereof:

FIG. 1 depicts a typical bicomponent spunbonding process;

FIG. 2 shows the typical process for hydroentangling using a drum entangler;

FIGS. 3A-3D compare a known tipped trilobal fiber cross-section (3A) to a trilobal fiber cross-section of the present invention (3B) and shows SEM micrographs illustrating a trilobal fiber of the invention in cross-section (3B) and fibrillated trilobal fibers where the core is wrapped by the fractured lobes or tips (3D);

FIGS. 4A-4B illustrate two exemplary cross-sections of trilobal fibers of the invention;

FIGS. 5A-5B illustrate two exemplary cross-sections of trilobal fibers of the invention with bicomponent core fiber components;

FIGS. 6A-6B illustrate two exemplary cross-sections of trilobal fibers of the invention with bicomponent core fiber components having a void space therein; and

FIGS. 7A-7B illustrate two exemplary cross-sections of trilobal fibers of the invention with bicomponent core fiber components having an inner and outer component of different cross-sectional shape.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

The present invention provides multicomponent, multilobal fibers that can be fibrillated to produce a plurality of microdenier fibers. As used herein, “microdenier” refers to a fiber having a denier of about 1 micron or less. As used herein, “multilobal” refers to fibers having a sheath component comprising 3 or more lobes that can be split from the core fiber component, and typically comprising 3 to about 18 lobes. The fibers of the invention can be used to form fabrics exhibiting high strength and durability, due in part to the fact that the multilobal fibers of the invention comprise a sheath fiber component that completely enwraps or encapsulates the core fiber component and forms the entire exterior surface of the fiber. By enwrapping the core completely during manufacture, the core fiber component is allowed to solidify and crystallize before the sheath fiber component. The core fiber component can be concentric or eccentric in location within the multicomponent fiber of the invention.

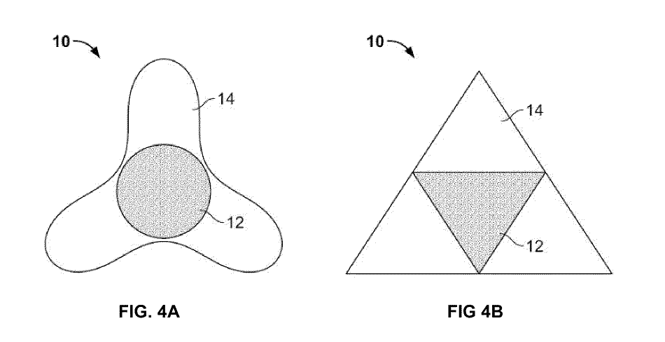

As shown in FIG. 4, the multicomponent fiber 10 of the invention can include a solid core fiber component 12 and a multilobal sheath fiber component 14 that encapsulates or enwraps the core fiber component. The cross-section of each fiber component can vary. For example, as shown in FIG. 4, the sheath fiber component 14 can comprise rounded lobes (4A) or triangular lobes (4B). The core fiber component can comprise a circular cross-section (4A) or a triangular cross-section (4B). Other potential cross-sectional shapes for the core fiber component include rectangular, square, oval, and multilobal.

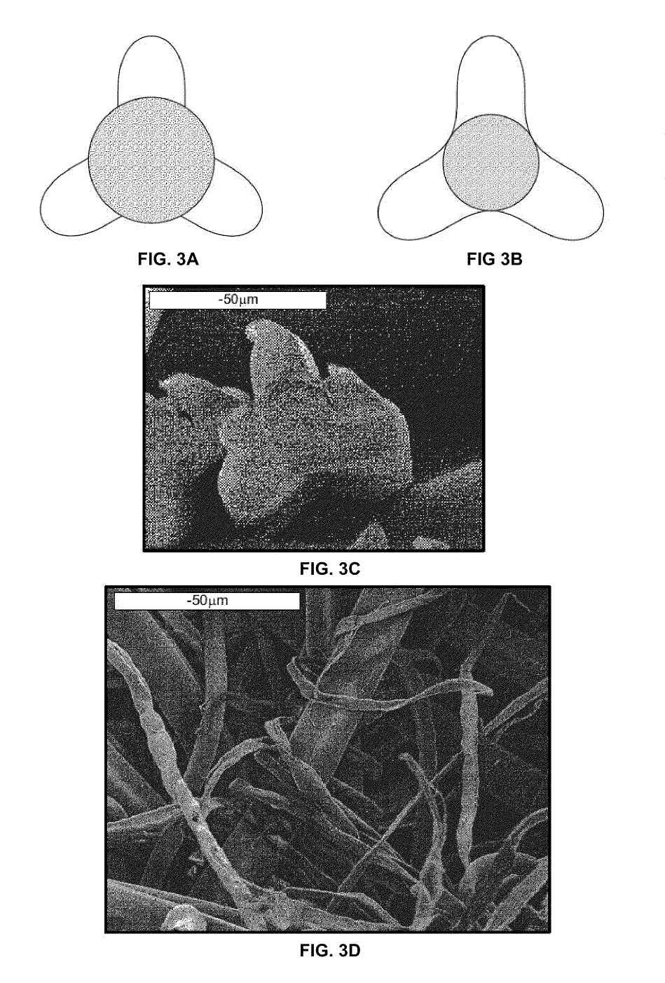

Fabrics formed using multicomponent fibers of the invention exhibit high strength and durability because the fibers are configured to fibrillate into a plurality of fiber components when mechanical energy is introduced to the multicomponent fiber using, for example, techniques such as needle punching and/or hydroentangling. As used herein, “fibrillate” refers to a process of breaking apart a multicomponent fiber into a plurality of smaller fiber components. The multicomponent, multilobal fibers of the invention will fibrillate or split into separate fiber components consisting of each lobe of the multicomponent fiber and the core. Thus, splitting or fibrillating the fiber will expose the core fiber component and produce multiple microdenier fiber components. For example, fibrillating a trilobal embodiment of the multicomponent fiber of the invention will result in four separate fiber components: the core fiber component and three separate lobes. It is preferable for the method of splitting the fibers also cause entangling of the fibers such that the fibrillated fiber components enwrap one another, as shown in FIG. 3D. For example, the separated lobe fiber components can enwrap and entangle the core fiber component, which increases the strength, cohesiveness, and durability of the resulting fabric. Hydroentangling is a particularly preferred technique that can be used to simultaneously fibrillate and entangle the fibers of the invention.

In one embodiment, the invention provides a multicomponent, multilobal fiber comprising a contiguous core fiber component enwrapped by a multilobal sheath fiber component such that the sheath fiber component forms the entire outer surface of the multicomponent fiber. Such a fiber configuration is shown in FIG. 3B and FIGS. 4-7. It is preferred for the core fiber component and the multilobal sheath fiber component to be sized such that the multicomponent, multilobal fiber can be fibrillated to expose the core fiber component and split the fiber into multiple microdenier fiber. Typically, the core fiber component forms about 10% to about 90% by volume of the multicomponent fiber (e.g., about 20% to about 80%), and specific embodiments include about 25% core fiber component/about 75% multilobal sheath fiber component, about 50% core fiber component/about 50% multilobal sheath fiber component, and about 75% core fiber component/about 25% sheath fiber component. It is preferable for the lobes of the multilobal sheath fiber component to be sized to produce microdenier fibers upon splitting. The core component can also be sized to produce a microdenier fiber upon splitting if desired. The modification ration of the multicomponent, multilobal fiber of the invention can vary, but is typically about 1.5 to about 4.

The core fiber component is advantageously a bicomponent fiber component comprising an outer component encapsulating an inner component. The inner component of the bicomponent core optionally comprises one or more void spaces. Typically, both the inner component and the outer component of the core fiber component have a cross-sectional shape independently selected from the following group: circular, rectangular, square, oval, triangular, and multilobal. Preferably, the inner component of the bicomponent core comprises the same polymer as the multilobal sheath fiber component.

In selecting the materials for the fiber components, various types of melt-processable polymers can be utilized as long as the sheath fiber component is incompatible with the core fiber component. When the core fiber component is bicomponent, only the outer component of the core must be incompatible with the sheath fiber component. Incompatibility is defined herein as the two fiber components forming clear interfaces between the two such that one does not diffuse into the other. The use of incompatible polymers in the sheath and core enhances the ability to split the fiber into multiple, smaller fiber components. In particularly, use of hydroentangling as the means for fibrillating the multicomponent of the invention is easier where the bond between the sheath and core components is sufficiently weak and particularly when the two components have little or no affinity for one another.

In one embodiment, the outer component of the bicomponent core and the multilobal sheath fiber component each comprise a different thermoplastic polymer selected from: polyesters, polyamides, copolyetherester elastomers, polyolefins, polyurethanes, polyacrylates, cellulose esters, liquid crystalline polymers, and mixtures thereof. A preferred copolyetherester elastomer has long chain ether ester units and short chain ester units joined head to tail through ester linkages. In one preferred embodiment, at least one of the outer component of the bicomponent core and the multilobal fiber sheath component comprises a polymer selected from the group consisting of nylon 6, nylon 6/6, nylon 6,6/6, nylon 6/10, nylon 6/11, nylon 6/12, and mixtures thereof. In yet another embodiment, the outer component of the bicomponent core comprises a polyamide or polyester polymer and the multilobal sheath fiber component comprises a polyolefin, polyamide, polyester, or co-polyester, wherein the core fiber component polymer and the multilobal sheath fiber component polymer are different. In one particular embodiment, the fiber components comprise nylon and polyester. The sheath fiber component preferably has a lower viscosity than the core fiber component. As noted above, the inner component of the bicomponent core may be the same polymer as the multilobal sheath fiber component or may be a different polymer.

In certain embodiments, it may be desirable for the core fiber component, or a part thereof, to be soluble in a particular solvent so that the core fiber component can be removed from the fiber (or a fabric comprising the fiber) during processing. Any solvent extraction technique known in the art can be used to remove the soluble polymer component at any point following fiber formation. For example, the core fiber component could be formed from a polymer that is soluble in an aqueous caustic solution such as polyglycolic acid (PGA), polylactic acid (PLA), polycaprolactone (PCL), and copolymers or blends thereof. In another embodiment, the core fiber component could be formed form a polymer that is soluble in water such as sulfonated polyesters, polyvinyl alcohol, sulfonated polystyrene, and copolymers or polymer blends containing such polymers.

The polymeric components of the multicomponent fibers of the invention can optionally include other components or materials not adversely affecting the desired properties thereof. Exemplary materials that can be present include, without limitation, antioxidants, stabilizers, surfactants, waxes, flow promoters, solid solvents, particulates, and other materials added to enhance processability or end-use properties of the polymeric components. Such additives can be used in conventional amounts.

Additives include any substances added to the polymer. Additives may dissolve or may remain un-dissolved in the fiber. In one embodiment, the additive-containing polymer is a polymer containing a particulate additive. The additives may be particulate matter which does not melt at the spinning temperatures used in the process of the present invention. Additives may be added for the purpose of modifying one or more of the properties of the polymer. For example, additives may be used to strengthen or reinforce the polymer, stabilize it to avoid decomposition, introduce various types of reactivity to the polymer, or to colorize the polymer composition. See, for example, Lutz & Grossman, Polymer Modifiers and Additives (2000). Such additives may include but are not limited to colorants, antioxidants, strengthening agents, stabilizers, flame retardants and smoke suppressants. Particular polymer additives include but are not limited to ceramic or metal oxide nanoparticles (e.g. titanium oxide or zinc oxide), silver nanoparticles, carbon nanotubes, photo-luminescent additives, clays, fiber retardant materials, surfactants, electrostatic charge stabilizers, and electrostatic charge inhibitors. The development of such embodiments allows for the preparation of fibers which may contain relatively high concentrations of additive-containing polymers. The additives may be present in amounts ranging from 2 to 10 percent without affecting spinnability. Exemplary particle size ranges are 100 nanometers to 1 micron.

In some embodiments, one component of the multicomponent fiber is an elastomer. An elastomer is a polymer that is able to recover its original shape after being stretched or deformed. Elastomers also encompass thermoplastic elastomers (“TPEs”). Thermoplastic elastomers are polymers with the properties of thermoset rubber but which can be easily reprocessed and remolded. See Bhowmick and Stephens, Handbook of Elastomers (2000), incorporated herein by reference, for an overview of the properties of various elastomers. “General purpose” elastomer types include styrene-butadiene rubber, butadiene rubber, and polyisoprene. “Specialty” elastomers are also available for specific applications, and include polychloroprene (also known as neoprene), acrylonitrile-butadiene rubber, hydrogenated nitrile rubber, butyl rubber, ethylene-propylene, ethylene-propylene rubber, silicone rubber, chlorosulfonated polyethylene, polyacrylate rubber, fluorocarbon rubber, chlorinated polyethylene rubber, epichlorhydrin rubber, ethylene-vinylacetate copolymer, styrene-isoprene block copolymer, and urethane rubber. For example, Dupont sells a number of elastomers ranging from Ascium®, an alkylated chlorosulfonated polyethylene, to Vamac®, an ethylene acrylic elastomer, to Hypalon®, a chlorosulfonated polyethylene, to Vitron® fluoroelastomer to neoprene polychloroprene. BASF markets a wide range of Elastollan® thermoplastic polyurethane elastomers. Dow produces and sells Diprane™ and Hyperlast™, two polyurethane elastomers, as well as Engage™ polyolefin elastomers, Enlite™ modified polyolefin elastomers, and Versify™ elastomers. Eastman markets copolyester ether Neostar™ elastomers. Teknor Apex's elastomer products include Medalist® medical elastomers, Uniprene® thermoplastic elastomers, Tekbond® proprietary elastomer compounds, Elexar® styrene block copolymer-based elastomers, Monprene® styrene block copolymer rubber and thermoplastic olefin resin-based thermoplastic elastomers, Tekron® block copolymer thermoplastic elastomers, and Telcar® thermoplastic rubber elastomer. Kraton Polymers, LLC offers elastomeric products including Kraton D SBS® (styrene-butadiene copolymers) and Kraton D SIS® (styrene-isoprene copolymers). Exxon Mobile has a range of specialty Vistamaxx™ elastomers including Exact™ ethylene alpha olefin copolymeric plastomers, Exxelor™ modifiers based on functionalized elastomeric and polyolefinic polymers, Santoprene™ thermoplastic vulcanizates, and Vistalon™ ethylene propylene diene rubber. GLS offers various elastomers ranging from Dynaflex™ styrenic block copolymeric TPEs and Dynalloy™ olefin block copolymeric TPEs, to Versaflex™ styrenic block copolymers, thermoplastic vulcanizates, and thermoplastic polyurethanes and Versollan® polyurethane elastomers. GLS also offers consumers custom-formulated thermoplastic elastomeric products designed for particular applications.

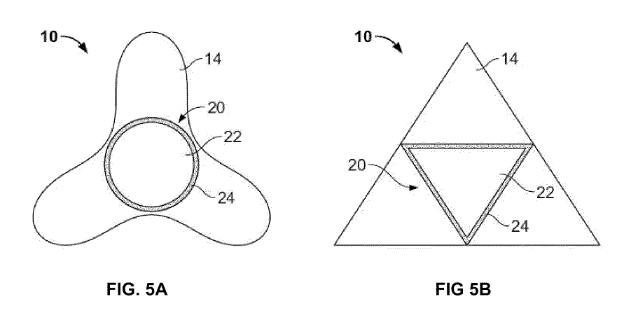

For certain applications, it may be desirable to minimize the percentage of the core fiber component that comprises a polymer dissimilar from the polymer of the multilobal sheath component. Although the presence of some portion of a dissimilar polymer in the core fiber component is necessary to aid splitting of the multicomponent fiber, the amount can be minimized using fiber configurations illustrated in FIGS. 5-7. As shown in those figures, the core fiber component 20 comprises an inner component 22 and an outer component 24 encapsulating the inner component. In certain preferred embodiments, the inner component 22 is constructed of the same polymer material as the sheath fiber component 14. In this manner, the dissimilar polymer is confined to the outer component 24 of the bicomponent core fiber component 20, which greatly reduces the overall amount of the dissimilar polymer in the multicomponent fiber 10. In certain embodiments, the outer component 24 can comprise no more than 20% by volume of the multicomponent fiber 10, typically no more than about 15% by volume, preferably no more than about 10% by volume, and more preferably no more than 5% by volume. In these embodiments, it may be desirable for the outer component 24 of the core fiber component 20 to be solvent-soluble as described above so that the outer component can be removed completely from the fiber, or fabric made therefrom, if desired.

This bicomponent core structure is advantageous in embodiments involving one or more elastomers or one or more polymer additives. The outer component of the bicomponent core preferably comprises an elastomer or additive-containing polymer. For example, in one embodiment, component 24 in FIGS. 5-7 comprises an elastomer or additive-containing polymer. An exterior sheath component 14 surrounding the bicomponent core makes up the outer surface of the fiber. Preferably, the exterior sheath component 14 completely encloses the core 20, covering the elastomer or additive-containing polymer. In one preferred embodiment, the polymer comprising the inner component of the bicomponent core 22 and the polymer comprising the exterior sheath layer component 14 are the same polymer. In such embodiments, it is preferable that neither the inner component of the bicomponent core 22 nor the exterior sheath component 14 is elastomeric. It is also preferable that the exterior sheath and the inner component of the bicomponent core be substantially free of particulate additives (e.g., those components preferably contain less than about 0.1 weight percent of such additives and are preferably completely free of such additives).

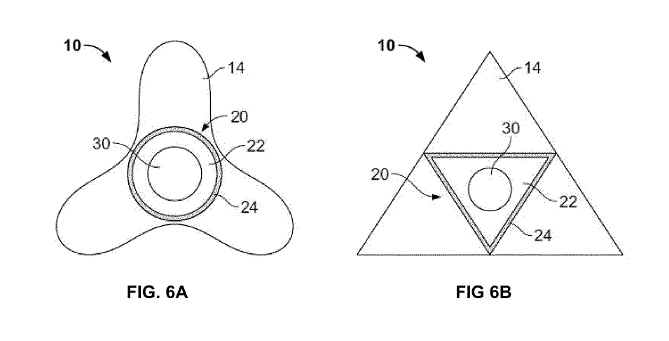

As shown in FIG. 6, the inner fiber component 22 may be hollow having a void space 30, which can reduce the overall cost of producing the multicomponent fiber by reducing the amount of polymer used and also advantageously alter the properties of the resulting fiber and any fabric made therefrom. Hollow fiber segments will provide additional bulk and resilience and will be preferred in applications requiring lower density. In such embodiments, the fiber components and the void may have the same or different cross-sectional shapes.

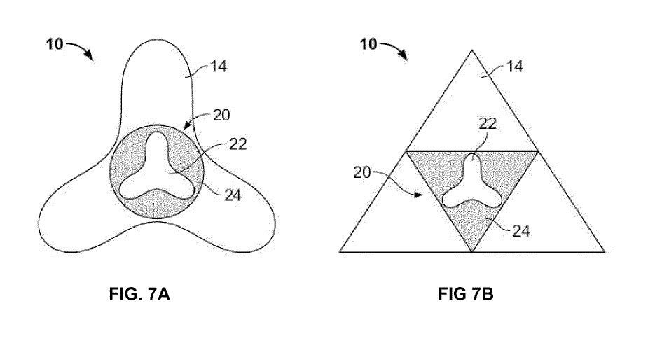

In one embodiment, the inner component 22 and outer component 24 of the bicomponent core component 20 have different cross-sectional shapes. For example, as illustrated in FIG. 7, the inner component 22 can have a multilobal cross-sectional shape and the outer component 24 can have a dissimilar cross-section, such as circular (7A) or triangular (7B). The combination of different cross sections leads to higher transport because of the increased capillarity and will also influence printability and the hand of the fabric.

The multicomponent fibers of the invention can be used to form filament yarns and staple yarns. In these embodiments, splitting or fibrillation of the fibers can be accomplished by texturing, twisting, or washing the fiber with a solvent. Alternatively, fabrics can be made using the fibers of the invention, including woven, knitted, and nonwoven fabrics.

In one preferred embodiment, a fabric is provided that is a hydroentangled nonwoven fabric. As explained above, hydroentangling can be used to provide the mechanical energy necessary to fibrillate the fiber. The amount of mechanical energy necessary to fibrillate the fiber will depend on a number of factors, including the desired level of fibrillation (i.e., the percentage of fibers to be split), the polymers used in the core and sheath components of the fiber, the volume percentage of the core and sheath components of the fiber, and the fibrillating technique utilized. Where hydroentangling is used as the fibrillating energy source, the amount of energy typically necessary is between about 2000 Kj/Kg to about 6000 Kj/Kg. In one embodiment, the hydroentangling method involves exposing a web of the multicomponent fibers of the invention to water pressure from one or more hydroentangling manifolds at a water pressure in the range of 10 bar to 1000 bar.

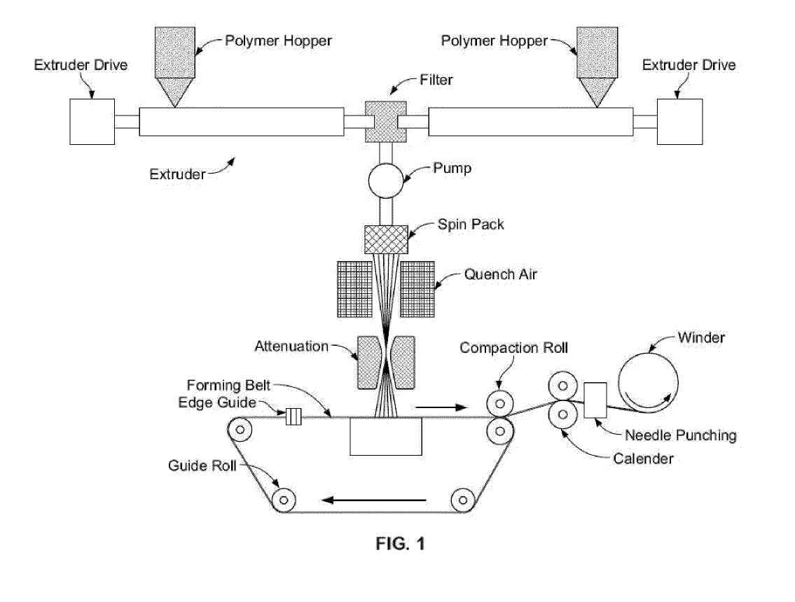

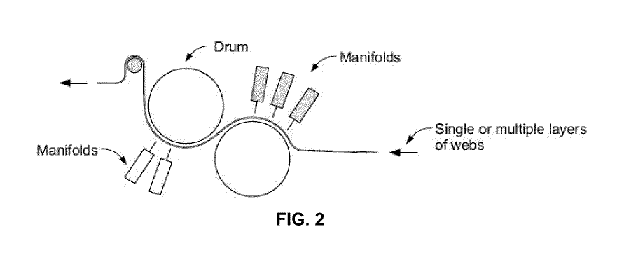

The invention also provides methods of preparing a fabric comprising the multicomponent fibers of the invention. In one preferred method, a nonwoven fabric comprising microdenier fibers is formed. An exemplary spunbonding process for forming nonwoven fabrics is illustrated in FIG. 1. As shown, at least two different polymer hoppers provide a melt-extrudable polymer that is filtered and pumped through a spin pack that combines the polymers in the desired cross-sectional multicomponent configuration. The molten fibers are then quenched with air, attenuated or drawn down, and deposited on a moving belt to form a fiber web. As shown, the process can optionally include thermal bonding the fiber web using heated calendaring rolls and/or a needle punching station. The fiber web can then be collected as shown in FIG. 1, although it is also possible to pass the fiber web through a hydroentangling process as shown in FIG. 2 prior to collection of the fiber web. As shown in FIG. 2, a typical hydroentangling process can include subjecting both sides of a fiber web to water pressure from multiple hydroentangling manifolds, although the process can also include impingement of water on only one side. The invention is not limited to spunbonding processes to produce a nonwoven fabric and also includes, for example, nonwoven fabrics formed using staple fibers formed into a web.

Thus, in one embodiment, the nonwoven fabric of the invention is provided by meltspinning a plurality of multicomponent, multilobal fibers comprising a contiguous core fiber component enwrapped by a multilobal sheath fiber component such that the sheath fiber component forms the entire outer surface of the multicomponent fiber, wherein the core fiber component and the multilobal sheath fiber component are sized such that the multicomponent, multilobal fibers can be fibrillated to expose the core fiber component and split the fibers into multiple microdenier fibers. The fibers are formed into a spunbonded web and fibrillated to expose the core fiber component and split the fibers into multiple microdenier fibers, thereby forming a nonwoven fabric comprising microdenier fibers.

During processing, the fibers are preferably drawn at a ratio of three or four to one and the fibers are spun vary rapidly, and in some examples at three and four thousand meters per minute or as high as six thousand meters per minute. With the core fiber component completely enwrapped, the core fiber solidifies more quickly than the sheath or tip fiber. Additionally, with the clear interface between the two components and low or no diffusion between the core and sheath fiber components, the multicomponent fibers of the invention are readily fibrillated.

The fibrillation step involves imparting mechanical energy to the multicomponent fibers of the invention using various means. For example, the fibrillation may be conducted mechanically, via heat, or via hydroentangling. Exemplary fibrillation techniques include:

(a) needle punching followed by hydroentangling without any thermal bonding wherein both the needle punching and the hydroentangling energy result in partial or complete splitting of the multilobal sheath and core;

(b) hydroentangling the web alone without any needle punching or subsequent thermal bonding wherein the hydroentangling energy result in partial or complete splitting of the multilobal sheath and core;

(c) hydroentangling the web as described in (a) above followed by thermal bonding in a calendar; or

(d) hydroentangling the web as described in (a) above followed by thermal bonding in a thru-air oven at a temperature at or above the melting temperature of the sheath fiber component to form a stronger fabric.

The invention also provides articles manufactured utilizing the high strength, nonwoven fabrics of the invention, such as tents, parachutes, outdoor fabrics, house wrap, awning, and the like. Some examples have produced nonwoven articles having a tear strength greater than ten pounds. Furthermore, the nonwoven fabrics of the invention can exhibit a high degree of flexibility and breathability, and thus can be used to produce filters, wipes, cleaning cloths, and textiles which are durable and have good abrasion resistance. If more strength is required, the core and sheath fiber components may be subjected to thermal bonding after fibrillation, or chemical binders such as self cross-linking acrylics or polyurethanes may be added subsequently.

Another feature of the invention is that the fiber materials selected are receptive to coating with a resin to form an impermeable material or may be subjected to a jet dye process after the sheath component is fibrillated. Preferably, the fabric is stretched in the machine direction during a drying process for re-orientation of the fibers within the fabric and during the drying process, the temperature of the drying process is high enough above the glass transition of the polymers and below the onset of melting to create a memory by heat-setting so as to develop cross-wise stretch and recovery in the final fabric. Alternatively, the fabric may be stretched in the cross direction by employing a tenter frame to form machine-wise stretch and recovery.

Hydroentangled nonwoven fabrics prepared according to the invention exhibit commercially acceptable levels of strength (e.g., tongue tear strength, strip tensile strength, and grab tensile strength), moisture vapor permeability, and pilling resistance. For example, certain preferred embodiments of the invention provide moisture vapor permeability of at least about 18,000 g/sq. m·day, more preferably at least about 19,000 g/sq. m·day, and most preferably at least about 20,000 g/sq. m·day. In certain embodiments, the moisture vapor permeability is about 18,000 to about 31,000 g/sq. m·day. Exemplary embodiments of the invention exhibit tongue tear strength of at least about 5 lbs, more preferably at least about 6 lbs. In certain embodiments, the range of tongue tear strength is about 5 to about 7 lbs in both the machine and cross-machine directions. Exemplary embodiments of the invention exhibit a grab tensile strength of at least about 120 lbs, more preferably at least about 125 lbs, and most preferably at least about 130 lbs in the machine direction. A typical range for machine direction grab tensile strength is about 120 lbs to about 140 lbs. In the cross-machine direction, exemplary embodiments of the invention exhibit a grab tensile strength of at least about 60 lbs, more preferably at least about 65 lbs, and most preferably at least about 70 lbs. A typical cross-machine range for grab tensile strength is about 60 lbs to about 80 lbs. All of the above numbers are for a fabric having a basis weight of 135 gsm. Preferred embodiments of the invention are comparable or superior in many performance categories to the commercially available EVOLON® brand fabrics constructed of pie wedge fibers that are split into microfilaments.

Fabrics prepared from elastomer-containing multilobal fibers may have various burst strengths and elasticities. For example, in some embodiments, the fabrics may have a machine direction or cross machine direction stretch and recovery characterized by a minimum stretch of at least about 5%, at least about 10%, or at least about 20%. In some embodiments, tested according to the methods of Example 2, the fabrics may be characterized as having a stretch of greater than about 30%, greater than about 40%, greater than about 50%, greater than about 60%, greater than about 70%, greater than about 80%, or greater than about 90%. The fabrics may be further characterized as having a recovery after ten seconds of at least about 30%, at least about 50%, at least about 70%, at least about 80%, or at least about 90%. In some embodiments, the fabrics exhibit a full recovery of at least about 80%, at least about 90%, or at least about 95% after twenty four hours. In some embodiments, the fabrics may be further characterized as having a recovery after one hour of at least about 80%, at least about 90%, at least about 95%, at least about 99%, or about 100%.

Exemplary embodiments wherein the fabrics are prepared from multilobal fibers comprising a polyester with elastomer-containing core have burst strengths measured according to the method set forth in Example 1 ranging from about 20 to about 60 PSI, preferably about 25 to about 50 PSI, and more preferably about 30 to about 40 PSI. In some embodiments, these fabrics may be characterized as having burst strengths greater than about 20 PSI, greater than about 30 PSI, greater than about 35 PSI, or greater than about 40 PSI. These fabrics possess as much as about 100% or more stretch, and instantaneous recovery (measured after 10 seconds) of about 80% to about 90%, or can be characterized as having at least about 80%, at least about 85%, or at least about 90% recovery after 10 seconds. These fabrics may exhibit time dependent recovery (measured after 1 hour) of about 90% to about 100%, or more preferably 95% to about 100%, or more preferably about 98% to about 100%.

Exemplary embodiments wherein the fabrics are prepared from multilobal fibers comprising a nylon-6 with elastomer-containing core have burst strengths measured according to the method set forth in Example 1 ranging from about 60 to about 120 PSI, preferably about 70 to about 100 PSI, and more preferably about 80 to about 90 PSI. In some embodiments, these fabrics may be characterized as having burst strengths greater than about 60 PSI, greater than about 70 PSI, greater than about 80 PSI, greater than about 90 PSI, or greater than about 100 PSI. These fabrics also have a tensile strength of over about 100 pounds and a stretch recovery measured after about 10 seconds in the range of about 60% to about 100%, about 70% to about 100%, about 80% to about 100%, or about 90% to about 100%, with recovery after about one hour of about 98% to about 100%. These fabrics may be characterized as having recovery after one hour of greater than 85%, greater than 90%, greater than 95%, greater than 98%, or greater than 99%.

The performance data set forth herein was generated using tests performed according to ASTM standard test methods commonly used by the industry.

### EXPERIMENTAL

Several examples are given below demonstrating the properties of the fabrics produced according to the invention.

### Example 1

### Elastomeric Example with Permanent Stretch and Recovery

These samples were made with the cross section in FIG. 7A, where the elastomer (a styrene/isoprene copolymer) was component 24 and components 14 and 22 were selected from nylon 6 for one example and polyester (polyethylene terephthalate with an intrinsic viscosity of 0.56—Eastman Chemical) for the other. The ratios were selected to be 20% by volume elastomer and 80% by volume nylon or polyester. One example was also run with a 50/50 ratio for the two polymers.

Elasticity (stretch and recovery) in the fabrics was achieved by spinning the fibers using the noted cross-section, collecting the fibers on an open mesh belt and using a water jet to break up and entangle the fibers. The method used to prepare the fabrics may affect the openness of the fabric structure. The open structure can be affected by the openness of the collecting belt (e.g. a 14 mesh belt was used for the nylon samples and a 40 mesh was used for the polyester sample) and/or by the spacing between orifices on the hydroentangling jet strip (e.g. the typical spacing between the orifices is about 500-600 μm, whereas the preferred spacing for these fabrics would be 1 to 4 mm.) These fabrics will shrink somewhat upon drying following hydroentangling or in subsequent processing where the fabric may be dyed or finished. These processes use high temperature that will result in the shrinkage of the fabric and the activation of the elastomeric properties of the fabric.

The basis weight was measured according to ASTM D-3776 standard. Burst strength was determined by using a TruBurst Model 810 and according to an ASTM D-3786-06 standard. Details of the set up are shown below.

TABLE 1
Parameters: Bursting Strength ASTM D3786-06

| No. of Tests | 5 | |
|---|---|---|
| Diaphragm | 1.00 | mm |
| Test Area (Dia) | 7.3 cm2 (30.5 mm) | |
| Inflation Rate | 4.87 | PSI/s |
| Correction Rate | 0.73 | PSI/s |
| Burst Detection | Normal | |
| Clamp Pressure | 87.02 | PSI |

The stretch and recovery was determined by using the TruBurst Model 810 equipment (James H. Heal & Company Ltd, UK). Details of the setup are shown below.

TABLE 2
Parameters: Extension and Recovery (cyclic) Multiaxial Test

| N Cycles | 5 | |
|---|---|---|
| Diaphragm | 1.50 | mm |
| Test Area (Dia) | 7.3 cm2 (30.5 mm) | |
| Inflation Rate | 2.90 | PSI/s |
| Target | 50% of burst strength | |
| Target Hold | 5 | s |
| Return Hold | 5 | s |
| Clamp Pressure | 44.96 | PSI |

The test stretches the fabric at a constant rate, holds the pressure and then allows the fabric to recover. The test was repeated five times to show any instantaneous decay or delayed recovery. This test is a multiaxial test that tests the fabric simultaneously in all directions and is a rigorous test. Currently, there are no ASTM test methods for cyclic fatigue of fabrics using TruBurst.

### Polyester/Elastomer

The elastomer chosen is from Kraton and is a block copolymer comprising styrene and isoprene. The choice of the elastomer is not limited to the Kraton polymer, however. The polyester used had an intrinsic viscosity of 0.56 from Eastman Chemical The fabric was collected on a 40 mesh belt. Various properties of the sample fabrics were measured and are reported below. The final basis weight of the fabric was 94 g/m².

TABLE 3
Polyester/Elastomer Basis Weight

| Sample # | oz/yd² | g/m² |
|---|---|---|
| 1 | 3.038 | 103.000 |
| 2 | 2.831 | 96.000 |
| 3 | 2.684 | 91.000 |
| 4 | 2.654 | 90.000 |
| 5 | 2.654 | 90.000 |
| Avg. | 2.772 | 94.000 |
| Std. Dev | 0.166 | 5.612 |

The burst results are shown below in Table 4. The fabric had a burst strength of about 35 PSI and showed a displacement of about 11 mm at rupture.

TABLE 4
Polyester/Elastomer Burst Strength

| | Bursting | | |
|---|---|---|---|
| | Strength | Height | Time |
| Sample # | (PSI) | (mm) | (sec) |
| 1 | 37.14 | 12.30 | 10.70 |
| 2 | 33.35 | 10.50 | 9.80 |
| 3 | 32.25 | 11.40 | 9.50 |
| 4 | 38.41 | 12.00 | 10.80 |
| 5 | 36.96 | 12.20 | 10.50 |
| Mean | 35.62 | 11.68 | 10.26 |
| Std. Dev | 2.66 | 0.75 | 0.58 |

The results for the stretch and recovery of various samples of this fabric are shown below in Table 5.

TABLE 5
Polyester/Elastomer Stretch and Recovery

| | Sample 1 | Sample 2 | Sample 3 | Sample 4 | Sample 5 |
|---|---|---|---|---|---|
| | Displ. | Displ. | Displ. | Displ. | Displ. |
| Cycle | mm | mm | mm | mm | mm |
| 1 | 6.4 | 6.3 | 6.1 | 6.2 | 6.2 |
| 2 | 6.8 | 6.8 | 6.4 | 6.4 | 6.6 |
| 3 | 6.9 | 6.9 | 6.5 | 6.7 | 6.7 |
| 4 | 7 | 6.9 | 6.5 | 6.7 | 6.7 |
| 5 | 7.1 | 7 | 6.6 | 6.8 | 6.8 |
| Mean | 6.8 | 6.8 | 6.4 | 6.5 | 6.6 |
| CV % | 4.05 | 3.8 | 3.31 | 3.75 | 3.6 |
| Q95% | 0.32 | 0.3 | 0.24 | 0.28 | 0.27 |
| Q95% Min | 6.5 | 6.5 | 6.2 | 6.3 | 6.3 |
| Q95% Max | 7.2 | 7.1 | 6.7 | 6.8 | 6.9 |
| % Decay | 10.94 | 11.11 | 8.2 | 9.68 | 9.68 |

These results show an instantaneous decay of about 10%, meaning that the fabric samples initially recover to about 110% of their original lengths. These are time-dependent properties and the fabrics recover to their original shapes and lengths after a period of time. The decay is due to the frictional constraints that prevent the structure from recovering fully instantly.

### Nylon-6/Elastomer

The same elastomer as used in the polyester/elastomer fibers described above was used in the preparation of nylon-6/elastomer fibers and fabric. The nylon was from BASF, and was a polyamide 6 with a viscosity of 2.7. The fabric was collected on a 14 mesh belt. The final basis weight of the fabric was 217 g/m².

TABLE 6
Nylon/Elastomer Basis Weight
ASTM D-3776

| Sample # | oz/yd² | g/m² |
|---|---|---|
| 1 | 6.282 | 213.000 |
| 2 | 6.665 | 226.000 |
| 3 | 6.665 | 226.000 |
| 4 | 6.253 | 212.000 |
| 5 | 6.194 | 210.000 |
| Avg. | 6.412 | 217.400 |
| Std. Dev | 0.234 | 7.925 |

The burst data is summarized below. The samples showed an average burst strength of 86 PSI and a displacement of 18 mm at rupture.

TABLE 7
Nylon/Elastomer Burst Strength

| | Bursting | | |
|---|---|---|---|
| | Strength | Height | Time |
| Sample # | (PSI) | (mm) | (sec) |
| 1 | 70.52 | 17.60 | 17.90 |
| 2 | 96.80 | 19.40 | 23.50 |
| 3 | 82.74 | 17.60 | 20.50 |
| 4 | 80.12 | 18.10 | 19.90 |
| 5 | 100.59 | 20.40 | 24.20 |
| Mean | 86.15 | 18.62 | 21.20 |
| Std. Dev | 12.39 | 1.24 | 2.62 |

The nylon samples were made to be more open and consequently, show a higher degree of stretch. They exhibit stretch and recovery similar to the polyester/elastomer samples as shown below in Table 8.

TABLE 8
Nylon/Elastomer Stretch and Recovery

| | Sample 1 | Sample 2 | Sample 3 | Sample 4 | Sample 5 |
|---|---|---|---|---|---|
| | Displ. | Displ. | Displ. | Displ. | Displ. |
| Cycle | mm | mm | mm | mm | Mm |
| 1 | 9.0 | 9.7 | 9.8 | 8.7 | 10 |
| 2 | 9.6 | 10.3 | 10.5 | 9.2 | 10.5 |
| 3 | 9.8 | 10.5 | 10.7 | 9.3 | 10.7 |
| 4 | 9.8 | 10.6 | 10.8 | 9.4 | 11 |
| 5 | 10.0 | 10.7 | 11 | 9.5 | 11 |
| Mean | 9.60 | 10.4 | 10.5 | 9.2 | 10.6 |
| CV % | 4.05 | 4.03 | 4.25 | 3.64 | 3.94 |
| Q95% | 0.45 | 0.48 | 0.51 | 0.39 | 0.48 |
| Q95% Min | 9.20 | 9.9 | 10 | 8.9 | 10.2 |
| Q95% Max | 10.10 | 10.8 | 11.1 | 9.6 | 11.1 |
| % Decay | 11.11 | 10.31 | 12.24 | 9.2 | 10 |

The data above show an instantaneous decay of about 9% to 11%. The fabric recovers fully however, after some time. The decay is due to the frictional constraints that prevent the structure from recovering fully instantly.

### Example 2

### Effect of Structure on Unidirectional Stretch and Recovery

An additional set of fabrics was produced and tested for the effect of structure on unidirectional properties of the fabric with respect to stretch and recovery. The fabrics tested include a 75% PET/25% elastomer material, a 75% PA6/25% elastomer material, and a 50% PA6/50% elastomer material. The polymers used in these materials were the same as those used in the previous examples (elastomer=Kraton styrene and isoprene block copolymer, PET=polyethylene terephthalate with an intrinsic viscosity of 0.56 from Eastman Chemical, PA6=polyamide 6 from BASF with a viscosity of 2.7).

The results of this additional study are summarized below in Table 9. The weights chosen were 100 and 150 g/m². These were entangled using a 100 mesh stainless steel mesh belt, and some samples were further entangled using an open mesh (14 or 20) polymer belt, as indicated below. The samples were tested according to ASTM test method for Stretch and Recovery Modified ASTM D3107-07, in which a dead weight of 3 pounds is hung from a fabric measuring 1″×6″. The degree of stretch in the fabric is noted and then the weight is removed and the recovered length is measured after a defined time interval. The data reported below are for recovery 10 seconds after removal of the weight and also forty-eight hours after removal of the weight. The fabrics were tested in the cross direction.

TABLE 9
Stretch and Recovery

| | Weight | Hydroentangling | Stretch | Deformation | Deformation |
|---|---|---|---|---|---|
| Material | (g/m²) | Surface | (%) | at 10 s (%) | at 48 h (%) |
| 75% PET/25% | 150 | 100 SS mesh | 44 | 9 | 6 |
| Elastomer | | | | | |
| 75% PET/25% | 150 | 100 mesh SS followed | 44 | 10 | 6 |
| Elastomer | | by 20 mesh polymer | | | |
| 75% PET/25% | 150 | 100 SS mesh followed | 47 | 10 | 7 |
| Elastomer | | by 14 mesh polymer | | | |
| 75% PA6/25% | 100 | 100 SS mesh | 53 | 6 | 3 |
| Elastomer | | | | | |
| 75% PA6/25% | 100 | 100 mesh SS followed | 66 | 8 | 5 |
| Elastomer | | by 20 mesh polymer | | | |
| 75% PA6/25% | 100 | 100 SS mesh followed | 55 | 6 | 3 |
| Elastomer | | by 14 mesh polymer | | | |
| 75% PA6/25% | 150 | 100 mesh SS | 32 | 4 | 2 |
| Elastomer | | | | | |
| 75% PA6/25% | 150 | 100 SS mesh followed | 34 | 3 | 1 |
| Elastomer | | by 20 mesh polymer | | | |
| 75% PA6/25% | 150 | 100 SS mesh followed | 34 | 3 | 1 |
| Elastomer | | by 14 mesh polymer | | | |
| 50% PA6/50% | 100 | 100 SS mesh | 87 | 10 | 6 |
| Elastomer | | | | | |
| 50% PA6/50% | 100 | 100 SS mesh followed | 98 | 10 | 7 |
| Elastomer | | by 20 mesh polymer | | | |
| 50% PA6/50% | 100 | 100 SS mesh followed | 90 | 10 | 5 |
| Elastomer | | by 14 mesh polymer | | | |
| 50% PA6/50% | 150 | 100 SS mesh | 63 | 6 | 2 |
| Elastomer | | | | | |
| 50% PA6/50% | 150 | 100 SS mesh followed | 67 | 5 | 3 |
| Elastomer | | by 20 mesh polymer | | | |
| 50% PA6/50% | 150 | 100 SS mesh followed | 66 | 4 | 2 |
| Elastomer | | by 14 mesh polymer | | | |

That which is claimed:

1. A multicomponent, multilobal fiber comprising a bicomponent core wherein the bicomponent core comprises an inner component and an outer component encapsulating said inner component, wherein the outer component is selected from the group consisting of an elastomer and a polymer containing a particulate additive, and wherein the bicomponent core is enwrapped by a multilobal sheath fiber component such that the sheath fiber component forms the entire outer surface of the multicomponent fiber, wherein the bicomponent core and the sheath fiber component are sized such that the multicomponent, multilobal fiber can be fibrillated to expose the bicomponent core and split the fiber into multiple microdenier fibers.

2. The fiber of claim 1, wherein the multilobal sheath has 3 to about 18 lobes.

3. The fiber of claim 1, wherein the inner component of the bicomponent core comprises one or more void spaces.

4. The fiber of claim 1, wherein both the inner component and the outer component of the bicomponent core have a cross-sectional shape independently selected from the group consisting of circular, rectangular, square, oval, triangular, and multilobal.

5. The fiber of claim 1, wherein both the inner component and the outer component of the bicomponent core have a round or triangular cross-section, wherein the inner component optionally comprises one or more void spaces.

6. The fiber of claim 1, wherein the inner component of the bicomponent core has a multilobal cross-sectional shape.

7. The fiber of claim 1, wherein the inner component of the bicomponent core comprises the same polymer as the sheath fiber component.

8. The fiber of claim 1, wherein the outer component of the bicomponent core is an elastomer.

9. The fiber of claim 8, wherein the elastomer is selected from the group consisting of styrene-butadiene rubber, butadiene rubber, polyisoprene, polyisoprene-polystyrene copolymer, polychloroprene, acrylonitrile-butadiene rubber, hydrogenated nitrile rubber, butyl rubber, ethylene-propylene rubber, silicone rubber, chlorosulfonated polyethylene, polyacrylate rubber, fluorocarbon rubber, chlorinated polyethylene rubber, epichlorhydrin rubber, ethylene-vinylacetate copolymer, and urethane rubber.

10. The fiber of claim 1, wherein the outer component of the bicomponent core is a polymer containing a particulate additive.

11. The fiber of claim 10, wherein the particulate additive is selected from the group consisting of ceramic nanoparticles, metal oxide nanoparticles, silver nanoparticles, carbon nanotubes, photo-luminescent additives, and surfactants, clays, fire retardants, electrostatic charge stabilizers, and electrostatic charge inhibitors.

12. The fiber of claim 1, wherein the outer component of the bicomponent core comprises less than about 25% by volume of the multicomponent fiber.

13. The fiber of claim 12, wherein the outer component of the bicomponent core comprises less than about 20% by volume of the multicomponent fiber.

14. The fiber of claim 13, wherein the outer component of the bicomponent core comprises less than about 15% by volume of the multicomponent fiber.

15. The fiber of claim 1, wherein the outer component of the bicomponent core is soluble in water or caustic solution.

16. A spunbonded fabric prepared by fibrillation of a plurality of fibers according to claim 1, said fibrillation causing the multicomponent fibers to split into a plurality of microdenier fibers.

17. The fabric of claim 16, wherein the exterior sheath component and the inner component of the bicomponent core comprise the same thermoplastic polymer.

18. The fabric of claim 16, wherein the outer component of the bicomponent core is an elastomer.

19. The fabric of claim 18, wherein the elastomer is selected from the group consisting of styrene-butadiene rubber, butadiene rubber, polyisoprene, polyisoprene-polystyrene copolymer, polychloroprene, acrylonitrile-butadiene rubber, hydrogenated nitrile rubber, butyl rubber, ethylene-propylene rubber, silicone rubber, chlorosulfonated polyethylene, polyacrylate rubber, fluorocarbon rubber, chlorinated polyethylene rubber, epichlorhydrin rubber, ethylene-vinylacetate copolymer, and urethane rubber.

20. The fabric of claim 16, wherein the outer component of the bicomponent core is a polymer containing a particulate additive.

21. The fabric of claim 20, wherein the particulate additive is selected from the group consisting of ceramic nanoparticles, metal oxide nanoparticles, silver nanoparticles, carbon nanotubes, photo-luminescent additives, surfactants, clays, fire retardants, electrostatic charge stabilizers, and electrostatic charge inhibitors.

22. The fabric of claim 16, wherein the multilobal sheath has 3 to about 18 lobes.

23. The fabric of claim 16, wherein the volume of the bicomponent core is about 10 to about 90 percent of the multicomponent fiber.

24. The fabric of claim 16, wherein the inner component of the bicomponent core and the sheath fiber component are made from a non-elastomeric thermoplastic polymer selected from the group consisting of polyesters, polyamides, polyolefins, polyurethanes, polyacrylates, cellulose esters, liquid crystalline polymers, and mixtures thereof.

25. The fabric of claim 16, wherein at least one of the inner component of the bicomponent core and the sheath fiber component comprises a polymer selected from the group consisting of nylon 6, nylon 6/6, nylon 6,6/6, nylon 6/10, nylon 6/11, nylon 6/12, and mixtures thereof.

26. The fabric of claim 16, wherein the inner component of the bicomponent core comprises one or more void spaces.

27. The fabric of claim 16, wherein both the inner and outer components of the bicomponent core have a cross-sectional shape independently selected from the group consisting of circular, rectangular, square, oval, triangular, and multilobal.

28. The fabric of claim 16, wherein both the inner and outer components of the bicomponent core have a round or triangular cross-section, wherein the inner component optionally comprises one or more void spaces.

29. The fabric of claim 16, wherein the inner component of the bicomponent core has a multilobal cross-sectional shape.

30. The fabric of claim 16, wherein the outer component of the bicomponent core comprises less than about 25% by volume of the multicomponent fiber.

31. The fabric of claim 30, wherein the outer component of the bicomponent core comprises less than about 20% by volume of the multicomponent fiber.

32. The fabric of claim 31, wherein the outer component of the bicomponent core comprises less than about 15% by volume of the multicomponent fiber.

33. The fabric of claim 16, wherein the outer component of the bicomponent core is soluble in water or caustic solution.

34. The fabric of claim 16, wherein the fabric is a hydroentangled nonwoven fabric.

35. The fabric of claim 34, wherein the fabric is a microdenier fabric prepared by fibrillating the multilobal fibers.

36. The fabric of claim 16, having a machine direction or cross machine direction stretch and recovery characterized by a stretch of at least about 10% and a recovery of at least about 50% after ten seconds and full recovery of at least about 90% after twenty four hours.

37. A method of preparing a nonwoven fabric comprising fibers with elastomeric or particulate additive-containing polymer components, comprising:
meltspinning a plurality of multicomponent fibers comprising a bicomponent core wherein the bicomponent core comprises an inner component and an outer component, wherein the outer component is selected from the group consisting of an elastomer and a polymer containing a particulate additive, wherein the bicomponent core is enwrapped by a multilobal sheath fiber component such that the sheath fiber component forms the entire outer surface of the multicomponent fiber; and
forming a spunbonded web comprising the multicomponent fibers.

38. The method of claim 37, wherein the bicomponent core and the sheath fiber component are sized such that the multicomponent, multilobal fibers can be fibrillated to expose the bicomponent core and split the fibers into multiple microdenier fibers.

39. The method of claim 38, further comprising fibrillating the multicomponent, multilobal fibers to expose the bicomponent core and split the fibers into multiple microdenier fibers to form a nonwoven fabric comprising microdenier fibers.

40. The method of claim 39, wherein said fibrillating step comprises hydroentangling the multicomponent, multilobal fibers.

41. The method of claim 40, wherein the hydroentangling step comprises exposing the spunbonded web to water pressure from one or more hydroentangling manifolds at a water pressure in the range of 10 bar to 1000 bar.

42. The method of claim 40, further comprising the step of thermal bonding of the nonwoven fabric prior to said fibrillating step.

43. The method of claim 40, further comprising needle punching the spunbonded web prior to said fibrillating step.
